(19) United States
(12) Patent Application Publication
(10) Pub. No.: US 2026/0161782 A1
(43) Pub. Date: Jun. 11, 2026

(54) FORENSIC DATA RECORDER

(71) Applicant: Rolls-Royce North American Technologies Inc., Indianapolis, IN (US)

(72) Inventors: Wayne T. Padgett, Indianapolis, IN (US); Takunda Masike, Indianapolis, IN (US)

(73) Assignee: Rolls-Royce North American Technologies Inc., Indianapolis, IN (US)

(21) Appl. No.: 18/975,697

(22) Filed: Dec. 10, 2024

(51) Int. Cl. G06F 21/55; G06F 21/56

(52) U.S. Cl. CPC G06F 21/556; G06F 21/566

(57) ABSTRACT

A cyber security data recorder may be provided that includes: a data recorder controller; a data recorder memory; and a data recorder input interface configured to receive a signal from an embedded system. The data recorder controller may read forensic data from the embedded system via the data recorder input interface. The data recorder controller may read samples of the signal at intervals that are random and unknown to the embedded system. Alternatively or in addition, the forensic data may be determined as a rate of jump instructions, a ratio of jump to non-jump instructions, and/or an instruction rate from the signal. The data recorder controller may store the forensic data in the data recorder memory.

### TECHNICAL FIELD

This disclosure relates to embedded systems and, in particular, to cyber security for embedded systems.

### BACKGROUND

In the event of a cyber security compromise of an embedded system, it is possible that no nonvolatile data will be stored on the hardware of the embedded system to support a forensic investigation of the incident. Data to support an investigation may be essential for preventing future incidents, especially in critical infrastructure. Embedded systems that support critical infrastructure and human safety often have minimal feature sets to reduce the work in verifying the correctness and integrity of the embedded system. However, these critical embedded systems are often the most impactful cyber-attack targets.

Forensic data stored outside of the embedded system may not be available or may be subject to corruption or destruction by a malicious actor. Embedded systems, especially those in critical infrastructure, may have complexity, power, cost, and/or space limitations that make data logging solutions impractical. As a result, most critical embedded systems have no capability to log any data that may provide insight into a cyber incident unless the incident results in a modification of the system firmware or other non-volatile storage. Moreover, vulnerabilities in firmware on embedded systems are often not patched in a timely manner because of the effort required to verify the correctness of the patched embedded system.

### BRIEF DESCRIPTION OF THE DRAWINGS

The examples may be better understood with reference to the following drawings and description. The components in the figures are not necessarily to scale. Moreover, in the figures, like-referenced numerals designate corresponding parts throughout the different views.

FIG. 1 illustrates an example of a cyber security data recorder that stores forensic data for an embedded system;

FIG. 2 illustrates a timeline showing example calculations of random intervals;

FIG. 3 illustrates a flow diagram of a first example of logic for gathering forensic data about an embedded system; and

FIG. 4 illustrates an example of a timeline showing sampling at random intervals, where the start of one of the intervals is random and the length of the intervals is fixed.

### DETAILED DESCRIPTION

In one example, a cyber security data recorder is provided that includes: a data recorder controller; a data recorder memory; and a data recorder input interface configured to receive a signal from an embedded system. The data recorder controller is configured to read forensic data from the embedded system via the data recorder input interface, the forensic data including samples of the signal from the embedded system. The data recorder controller is configured to read the samples at intervals that are random and unknown to the embedded system. The data recorder controller is further configured to store the forensic data in the data recorder memory.

One interesting feature of the systems and methods described below may be providing an economical means for an embedded system to record data about the embedded system's behavior in a manner protected from corruption or erasure by malicious activity on the compromised embedded system itself. The cyber security data recorder may remain subject to various forms of physical tampering (mitigated by whatever tampering protections are implemented) but may still provide strong guarantees of data integrity from a cyber compromise of the embedded system being monitored.

Alternatively, or in addition, an interesting feature of the systems and methods described below may be to enable post-accident analysis and prevention of future events. The availability of high-integrity forensic data may be considered a safety enhancement as well as a security enhancement for safety critical embedded systems.

Alternatively, or in addition, an interesting feature of the systems and methods described below may be that, if the embedded system being monitored requires any safety certification, the cyber security data recorder will have minimal impact on the obtaining the safety certification. This is because the cyber security data recorder's isolation provides very few ways its failure may impact the safe operation of the embedded system.

For purposes of promoting an understanding of the principles of the disclosure, reference will now be made to the examples illustrated in the drawings, and specific language will be used to describe the same. It will nonetheless be understood that no limitation of the scope of the disclosure is intended by the illustration and description of certain examples. In addition, any alterations and/or modifications of the illustrated and/or described example(s) are contemplated as being within the scope of the present disclosure. Further, any other applications of the principles of the disclosure, as illustrated and/or described herein, as would normally occur to one skilled in the art to which the disclosure pertains, are contemplated as being within the scope of the present disclosure.

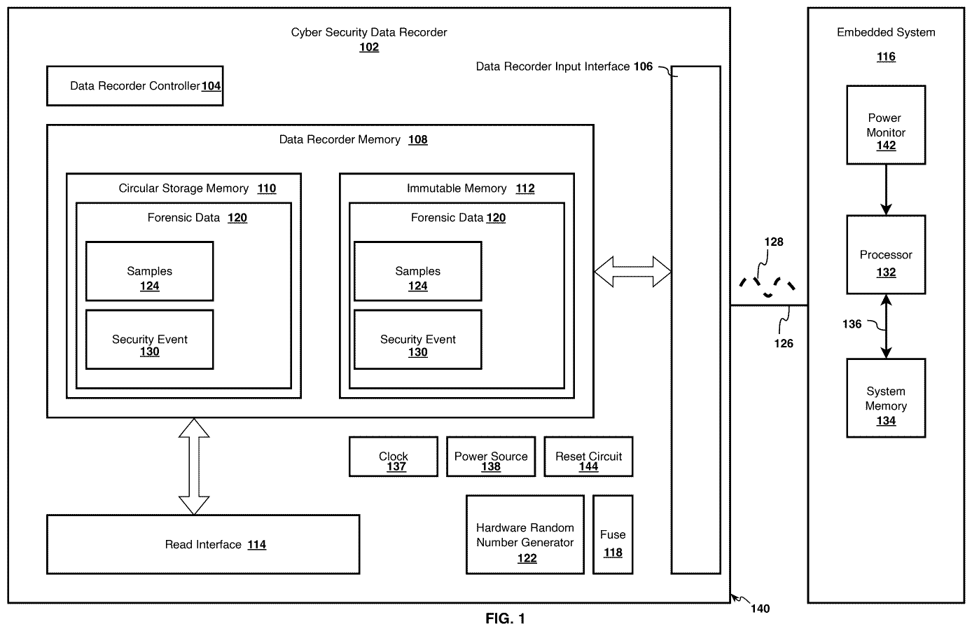

FIG. 1 illustrates an example of a cyber security data recorder 102 that stores forensic data 120 for an embedded system 116. FIG. 1 also illustrates an example of a cyber security system 140 for recording forensic data 120 for the embedded system 116.

The example of the cyber security data recorder 102 in FIG. 1 includes a data recorder controller 104, a data recorder input interface 106, a data recorder memory 108, a read interface 114, and a hardware random number generator 122. The cyber security system 140 includes the cyber security data recorder 102 and/or one or more of the components of the cyber security data recorder 102.

The data recorder input interface 106 may be any hardware over which a signal 128 may be received. Examples of the data recorder input interface 106 may include a connector configured to receive a wire, a pin for electrically coupling to a printed circuit board, and/or any other wired interface electrically coupled to, or configured to couple to, a line 126 to the embedded system 116. Alternatively or in addition, the data recorder input interface 106 may include an electro-optical receiver, an electro-optical transceiver, and/or any other device configured to receive an optical signal.

The line 126 may include one or more lines. Each of the lines may be a wire, a circuit trace, any other electrical conductor, an optical wave guide, an optical fiber, and/or any other tangible, physical signal carrier. The signal 128 may include one or more signals. The signal 128 and/or signals may be analog and/or digital. Each of the lines may include a corresponding one of the signals.

During operation of the cyber security data recorder 102, the data recorder controller 104 may read the forensic data 120 from the embedded system 116 via the data recorder input interface 106. The forensic data 120 read by the data recorder controller 104 may include samples 124 of the signal 128. The data recorder controller 104 may store the forensic data 120 in the data recorder memory 108 for later analysis. The forensic data 120 may include any data that captures an indication of the behavior of the embedded system 116. For example, the forensic data 120 may include CPU power consumed by a processor 132 of the embedded system 116. As another example, the forensic data 120 may include memory access rates of the system memory 134 of the embedded system 116.

The data recorder memory 108 may include non-volatile memory such as a circular storage memory 110 (re-writable) and/or an immutable memory 112 (write-once memory). The non-volatile memory helps ensure that the forensic data 120 about the past behavior of the embedded system 116 will be available after power is removed from the cyber security data recorder 102. The circular storage memory 110 may be any re-writeable memory configured to overwrite older and/or oldest data in the circular storage memory 110 after the circular storage memory 110 is used up. The decision to use the circular storage memory 110 or the immutable memory 112 or the amount of each depends on factors such as storage size, data rate, device life, and whether the data recorder memory 108 is replaceable. The immutable memory 112 may provide better security properties but may not satisfy other system and program requirements better met with the circular storage memory 110.

The data recorder memory 108 may be isolated from the embedded system 116 with no connected interface other than the data recorder input interface 106. In other words, the data recorder input interface 106 may be the only interface between the cyber security data recorder 102 and the embedded system 116. The data recorder input interface 106 enables the data recorder controller 104 to sample the signal 128, but not to receive any instruction from the embedded system 116 and perhaps not to send any data to the embedded system 116. The embedded system 116 is unable to access the data recorder memory 108 via the data recorder input interface 106. In other words, the embedded system 116 may neither read from nor write to the data recorder memory 108. Instead, the embedded system 116 merely provides the signal 128 that the data recorder controller 104 samples. This feature counters potential anti-forensic techniques by ensuring a malicious actor will not have access to read or overwrite the forensic data 120 or perform other malicious attacks on the cyber security data recorder 102 through the data recorder input interface 106.

The cyber security data recorder 102 may control the format and content of the forensic data 120 stored in data recorder memory 108. In some examples, the cyber security data recorder 102 controls the rate at which the data recorder memory 108 capacity is consumed regardless of the behavior of the embedded system 116. If the cyber security data recorder 102 is monitoring the embedded system 116 for a type of the forensic data 120, such as a security event 130, the cyber security data recorder 102 may still control the rate of memory consumption even if the type of the forensic data 120 starts occurring at an unusually high frequency. In one such example, the data recorder controller 104 may stop logging the type of the forensic data 120 in the data recorder memory 108 in response to a determination that a rate at which the type of forensic data 120 is detected exceeds a limit. Alternatively, or in addition, the data recorder controller 104 may throttle a rate at which the data recorder controller 104 stores the type of the forensic data 120 in the data recorder memory 108 in response to a determination that a rate at which the type of the forensic data 120 is detected exceeds a limit. Alternatively, or in addition, the data recorder controller 104 may switch to storing a summary of the type of the forensic data 120 in response to a determination that a rate at which the type of forensic data 120 is detected exceeds a limit.

This rate limiting feature helps to protect the data recorder memory 108 from maliciously formatted data or from attempts to overwrite or completely fill the data recorder memory 108. For example, if a malicious actor attempts to fill the data recorder memory 108 with records of the security event 130, such as a failed authentication event, the data recorder controller 104 may record instances of the security event 130 until a data rate limit is reached, after which, the data recorder controller 104 may only log a count of the security events per unit of time until the data rate falls below the data rate limit again. Therefore, the cyber security data recorder 102 may be forced to reduce the detail of the security events in the data recorder memory 108, but the data recorder memory 108 may be prevented from being filled faster than the data rate limit.

In some examples, the signals 128 from the embedded system 116 may be selected to measure critical behaviors of the embedded system 116 that may not be modified without substantially changing the function of the embedded system 116 and/or without changing the physical hardware of the embedded system 116. Alternatively or in addition, the signals 128 may be chosen to increase the usefulness of the forensic data 120 to a forensic investigator and/or to decrease the memory capacity requirements of the data recorder memory 108. Positive characteristics of the forensic data 120 may include the ability to detect anomalous behavior, the ability to explain anomalous behavior, and to detect the number and types of operations occurring after the onset of anomalous behavior. Examples of forensic data 120 may include measurements of CPU power via averages over a regular or irregular interval, snapshots at a specific event, and/or any other type of information to characterize normal behavior in a way that the processor 132 of the embedded system 116 produces a unique output that would most likely change with any change in functional behavior the embedded system 116, thereby making functional changes in the embedded system 116 identifiable in the recorded data.

Another example of the forensic data 120 may include memory access rates of the system memory 134 of the embedded system 116 over regular intervals, where the memory access rates may be based on the signals 128 from the physical memory bus (not shown) of the embedded system 116, where the memory access rates are computed internally to the cyber security data recorder 102, not rates reported by the embedded system 116. In some examples, the signals 128 may include signals from an instruction bus 136 of the embedded system 116. In such examples, the forensic data 120 may include a rate of jump instructions, a ratio of jump to non-jump instructions, instruction rates, and/or any other information that may expose changes in program control flow. This feature helps to protect the forensic data 120 from attempts to hide malicious operation by reproducing normal measurements while changing the actual operation of the embedded system 116. The forensic data may include any side channel data, such as memory access patterns, temporal behavior, performance counters, system traces, instruction sequences, control-flow transfers, counts of accesses to memory blocks over an interval (histogram), and counts of rates of other instruction types (I/O instructions, for example).

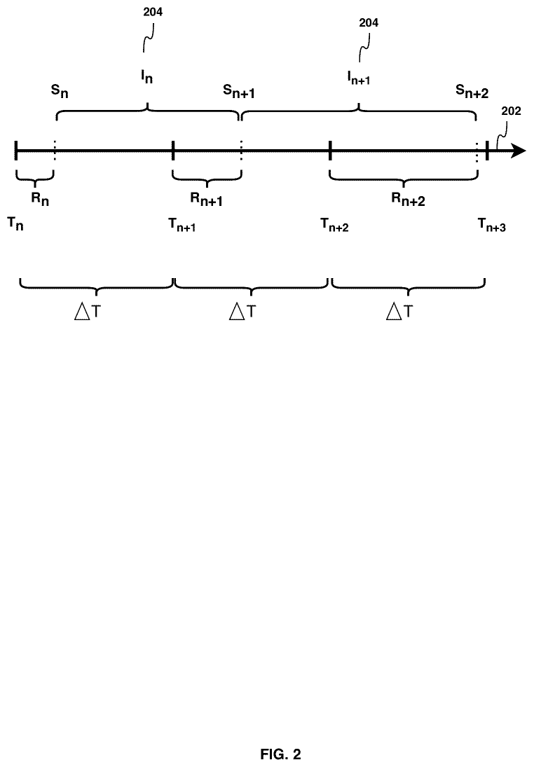

In some examples, the data recorder controller 104 is configured to read the samples 124 at intervals that are random and unknown to the embedded system 116. Despite reading the samples 124 at random intervals, the samples 124 may still be subject to data rate constraints. This feature may prevent an attacker from using knowledge of the time of the data recording event to avoid observation. The hardware random number generator 122 may generate random numbers on which the random intervals are based. For example, FIG. 2 illustrates an example of a timeline 202 showing the calculation of random intervals 204, Iₙ and _{In+1}, such that the samples 124 are subject to a data rate limit. In the illustrated example, times Tn, Tn+1, and so on, (Tᵢ) are spaced evenly along the timeline 202 every ΔT time units. The samples 124 are taken randomly within each ΔT. As a result, on the average, the samples are taken at a data rate of about one per ΔT time units. The samples 124 are taken at Sₙ, Sₙ₊₁, and Sₙ₊₂, where Sᵢ is equal to Tᵢ+Rᵢ, and Rᵢ is a random number. The hardware random number generator 122 or other true random number generator (TRNG) generates Rᵢ as a random number between 0 and ΔT. In other words, the random intervals 204 may be based on numbers generated by the hardware random number generator 122.

The data recorder controller 104 may be configured to use any method of sampling and storing the samples 124 that may be traced back to normal or abnormal functional operation of the embedded system 116 and be subject to the data rate limit. As explained above, the data rate limit may be a limit on the rate of consumption of the data recorder memory 108. In addition, varying the timing and/or rate of the data sampling unpredictably helps protect the logging of the forensic data 120 in the data recorder memory 108 from an adversary restricting abnormal operations of the embedded system 116 to times when the sampling is known by the adversary not to be occurring or is at least only sampling less quality data. Therefore, it may be advantageous to vary sample times randomly as shown in FIG. 2. This approach may be generalized to a wide variety of unpredictable sampling algorithms that vary sample rates and the timing of sample rate changes within an average data rate limit based on the hardware random number generator 122 or other random number generator.

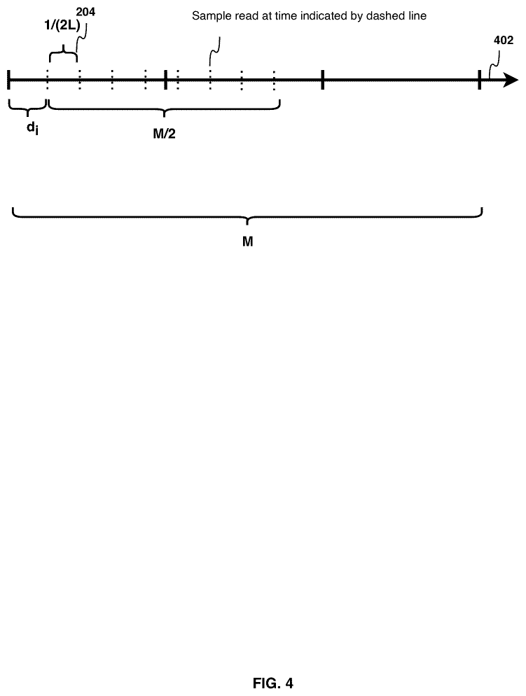

In one such example, the start of at least one of the intervals 204 is random and the length of the intervals 204 for at least a set of the intervals 204 is fixed. FIG. 4 illustrates an example of a timeline 404 showing sampling at random intervals 204, where the start of one of the intervals 204 is random, the length of the intervals 204 is fixed, and the average sampling rate remains within a fixed average sample rate. In the illustrated example, the following parameters are provided: a fixed average sample rate L (for example, number of samples per second) that is within the data rate limit, an averaging window M (for example, seconds), and a random delay interval dᵢ (for example, seconds). The random delay interval dᵢ is set to a random number between 0 and M/2. The data recorder controller 104 may read the samples 124 at a rate of 2L for a period of M/2 beginning dᵢ after the beginning of averaging window index i. In this manner, the data recorder controller 104 maintains its fixed average sample rate, L, while producing higher sample rate (2L) data for a period of time (M/2), and the adversary cannot predict whether sampling will occur or not at any given moment.

This method may be further generalized by choosing a rate factor, f, and recording samples at a rate of f*L for a period of M/f using a dᵢ between 0 and M−(M/f). The rate factor f may be chosen randomly from a set of pre-determined acceptable values (from a single fixed value up to and including all possible representable values between limits). This method may be further generalized by dividing each averaging window into k sub-windows of length N=M/k and index j. A set of k rates {l₁, l₂, . . . , lₖ} (unique or repeating) may be chosen such that the average rate L over the full window is fixed, regardless of the order that the k rates are implemented. Therefore, each sub-window j may use a sampling rate of lⱼ and in each new window i, the set of rates may be randomly rearranged. If the number of rates k is chosen to be very large, this method may cover all representable rates for a finite data type, or k may be very small to simplify the method to the previous example, where k is 1 and f is 2. This method may be further generalized by allowing the length of each sub-window to vary randomly between limits Nₘᵢₙ and Nₘₐₓ so that the total number of sub-windows varies randomly in each averaging window i, and the average sample rate Lᵢ of each window may also vary. Alternatively, if it is desired to set a peak data rate smaller than the worst case rate in this method, a maximum number of samples per averaging window may be set so that when it is exceeded (or computed to be possible to exceed given the remaining samples in the averaging window) the sample rate is immediately set to the minimum rate for the remainder of the averaging window. Alternatively, the probability mass functions for selecting sub-window lengths and sub-window sample rates may be adjusted to make exceeding the maximum desired data rate arbitrarily unlikely. Accordingly, if the data recorder controller 104 is configured to read the samples 124 at intervals that are random, this means that the start of at least one of the intervals and/or the length of at least one of the intervals is random. Therefore, if the data recorder controller 104 is configured to read the samples 124 at randomly varying constant sampling rates, then the data recorder controller 104 may be said to be configured to read the samples 124 at intervals that are random.

Notably, reading the samples 124 at randomly varying constant sampling rates may make it easier to characterize normal behavior of the embedded system 116 at each of the constant rates than with other approaches. From there, each snapshot of the samples 124 may subsequently be compared to expected behavior in a more automatable way for anomaly detection.

As used herein, the term “random” includes both purely random and partially random. The term “partially random” means that while a system or process has some element of randomness involved, it also has a portion that is governed by deterministic rules, meaning the outcome is not necessarily entirely left to chance.

The hardware random number generator 122 may be a device that generates random numbers from a physical process capable of producing entropy. In some examples, the hardware random number generator 122 may rely on the physical process to generate a “seed” for a pseudorandom number generator, where the pseudorandom number generator generates the subsequent random numbers.

In some examples, the cyber security data recorder 102 may monitor the embedded system 116 for an occurrence of the security event 130 and, in response to detection of the security event 130, start recording the forensic data 120 or a type of the forensic data 120 in the data recorder memory 108. For example, the security event 130 may be a reset of the embedded system 116, a memory access operation on the system memory 134 within a determined memory address range, or any other event that may have a higher-than-average chance of occurring on or around the time of malicious activity. The cyber security data recorder 102 may start recording CPU power usage and/or any other information that may expose changes in program control flow for a predetermined or determined interval after detection of the security event 130. The cyber security data recorder 102 may record the forensic data 120 within the data rate limit as described above.

The circular storage memory 110 may operate as a pre-event buffer in which the forensic data 120 relevant to the security event 130 may be stored prior to detection of the security event 130. Upon detection of the security event 130, the cyber security data recorder 102 may copy the forensic data 120 in the pre-event buffer or a portion thereof to the immutable memory 112 or otherwise preserve the forensic data 120 relevant to the security event 130. In some examples, the cyber security data recorder 102, in addition to preserving the forensic data 120 available in the pre-event buffer, may start and/or continue recording the forensic data 120 detected on or after the security event 130. Thus, the pre-event buffer may continuously keep an interval of the forensic data 120 (such as CPU power) so that the forensic data 120 collected before the triggering security event 130 may be captured.

The samples 124 are readings of the signal 128. Alternatively or in addition, the samples 124 may be derived from the readings of the signal 128. For example, the samples 124 may be any encoding of the signal 128.

In some examples, higher resolution snapshots (more frequent sampling) of behavior of the embedded system 116, such as CPU power consumed by the processor 132 of the embedded system 116, may be taken at the random intervals 204 (without violating data rate limits) to prevent an attacker from avoiding observation at otherwise predictable intervals. The CPU power use may be provided to the cyber security data recorder 102 by a power monitor 142 included in the embedded system 116. Specifically, the power monitor 142 may provide a power reading in the signal 128 over the line 126 to the data recorder input interface 106. The power reading identifies the power consumed by the processor 132 of the embedded system 116.

The cyber security data recorder 102 may be isolated from the embedded system 116 in lower-level interfaces. For example, the cyber security data recorder 102 may include a clock 137, a power source 138, and/or a reset circuit 144 independent of a corresponding clock, a corresponding power source, and/or a corresponding reset circuit of the embedded system 116. This may protect the cyber security data recorder 102 from interference via unintended dependencies on the behavior of the embedded system 116.

Given that the forensic data 120 is to be accessible to a forensic investigator after a cyber security event, the cyber security data recorder 102 needs the read interface 114. The forensic data 120 may be read from the data recorder memory 108 via the read interface 114. However, the read interface 114 may be protected from the embedded system 116 by not being connected to the embedded system 116. In some examples, the read interface 114 may be protected from unauthorized access, such as an insider threat actor who may have physical access to the cyber security data recorder 102 by including one or more tamper protection features.

One example of a tamper protection feature includes an arrangement requiring physical removal of the cyber security data recorder 102 from a circuit board to access the read interface 114. For example, the read interface 114 may be located on a side of an integrated circuit that faces the circuit board. As a result, the read interface 114 may be accessible only if the cyber security data recorder 102 and/or the cyber security system 140 is physically separated from the circuit board. A second example of a tamper protection feature includes the cyber security data recorder 102 having no external interface capable of writing to the data recorder memory 108.

A third example of a tamper protection feature includes the read interface 114 requiring cryptographic authentication to access the data recorder memory 108 via the read interface 114. A fourth example of a tamper protection feature includes the cyber security data recorder 102 providing cryptographic signatures of the forensic data 120 thereby authenticating the forensic data 120 stored in and read from the data recorder memory 108. In some examples, the cyber security data recorder 102 may implement one or more standards included in the Trusted Platform Module (TPM), which is an international standard for a secure cryptoprocessor, a microcontroller configured to secure hardware through integrated cryptographic keys. For example, the cyber security data recorder 102 may be implemented in an integrated circuit chip that conforms to the ISO/IEC 11889 standard. A fifth example of a tamper protection feature includes pairing the cyber security data recorder 102 with a physically unreproducible function (PUF)-based key in addition to a cryptographic key to provide two-factor authentication protection against unauthorized access to the forensic data 120. A sixth example of a tamper protection feature includes the cyber security data recorder 102 entering a mode that disables further storing of and/or changes to the forensic data 120 in the data recorder memory 108.

In some examples, the cyber security data recorder 102 may be implemented in a discrete field programmable gate array (FPGA), application specific integrated circuit (ASIC), microcontroller, or System-on-a-Chip (SOC) that includes the data recorder memory 108 as non-volatile memory. The cyber security data recorder 102 may be implemented as an on-chip peripheral of a customized processor or SOC, or as a component in a Multi Chip Module (MCM).

Notably, the data recorder input interface 106, the read interface 114, and/or the data recorder memory 108 are not necessarily digital. In fact, the cyber security data recorder 102 having analog interfaces and storage may be more secure against tampering and, as explained below, potentially capable of higher data density.

The cyber security data recorder 102 may be configured to be difficult to remove or replace to help prevent data tampering. Therefore, without additional features, if the data recorder memory 108 only includes the immutable memory 112, then the cyber security data recorder 102 may need to store data at a rate that enabled the cyber security data recorder 102 to not run out of storage for the expected life of the embedded system 116. Alternatively, if the data recorder memory 108 includes re-writable memory such as the circular storage memory 110, the forensic data 120 may need to be stored at a rate that would allow the oldest data to be overwritten after a length of time or operation appropriate to the system security design, and that would not exceed the rewrite limit of the data recorder memory 108 within the expected life of the embedded system 116.

In some examples, the data recorder memory 108 may include a flash memory device that is external to the cyber security data recorder 102. The flash memory device may be dedicated to the cyber security data recorder 102 to increase its memory capacity. Depending on the system security case and physical implementation, having the external flash memory device may reduce the tamper resistance of the forensic data 120 and increase the attack surface available to malicious actors.

As mentioned earlier above, the data recorder memory 108 may include the immutable memory 112 and the re-writeable memory, such as the circular storage memory 110. Nothing requires that all the data recorder memory 108 be either immutable or re-writeable storage. Both types of memory may be included either on a single device or on separate devices, with equal or unequal allocations of data storage. There may be an advantage to using both type of memory because the immutable memory 112 may have lower data rate limits and therefore lower resolution recording, while the rewriteable memory may be capable of a higher data rate limit and therefore more detailed logs subject to the tradeoff between data rate and the length of the record available before overwriting occurs.

In a lower cost and more limited functionality example of the cyber security data recorder 102, the data recorder memory 108 may consist of nothing more than the fuse 118 or set of fuses that the data recorder controller 104 may cause to blow in order to record the occurrence of the security event 130 in an immutable way. An example of the security event 130 that could be detected and logged by blowing the fuse 118 is the detection of an attempt to boot firmware that fails authentication checks. The blown fuse provides evidence of the security event 130 for investigators. Although this example does not mitigate a “filling the log” attack, the fuse 118 being blown may be enough to indicate such an attack occurred. Various types of incremental improvements on this approach may be implemented such as configuring the fuse 118 to be replaceable or erasable by a maintainer but not directly by the embedded system 116. This enables the cyber security data recorder 102 to return to service after a “filling the log” attack and reduce the impact of such an attack.

The fuse 118 is an electrical safety device that typically provides overcurrent protection to an electrical circuit. The fuse 118 may include a metal wire or strip that melts when current higher than a predetermined threshold passes through it. The fuse 118 is a sacrificial device, meaning that once the fuse 118 is blown (in other words, the wire or strip melts), then the fuse 118 is meant to be physically replaced.

The data recorder controller 104 may include any one or more devices that perform logic operations. The data recorder controller may include a controller, a microcontroller, a general processor, a central processing unit, a graphics processing unit, an application specific integrated circuit (ASIC), a digital signal processor, a field programmable gate array (FPGA), a digital circuit, an analog circuit, a controller, a microcontroller, any other type of processor, or any combination thereof. The data recorder controller 104 may include one or more components operable to execute computer executable instructions or computer code embodied in the data recorder memory 108 or in other memory to carry out the functions of the cyber security data recorder 102. One or more of the components of the data recorder controller 104 may be distributed across components of the cyber security data recorder 102. For example, a component of the data recorder controller 104 may be included in the read interface 114 and may be configured to read the forensic data 120 from the data recorder memory 108 and provide such data as output of the read interface 114.

The data recorder memory 108 may be any device for storing and retrieving data or any combination thereof. The data recorder memory 108 may include non-volatile and/or volatile memory, such as a random access memory (RAM or DRAM), solid state memory, flash memory, a read-only memory (ROM), an erasable programmable read-only memory (EPROM), flash memory, and/or one or more fuses. Alternatively or in addition, the data recorder memory 108 may include a magnetic (hard-drive), or any other form of data storage device.

The embedded system 116 is any combination of computer hardware and software designed and/or programmed for a specific purpose as opposed to a general-purpose computing device. In some examples, the embedded systems 116 may not be programmable by an end user. Alternatively, or in addition, the embedded system 116 may control a physical system and have one or more real-time performance requirements. Alternatively, or in addition, the embedded system 116 may have stricter SWAP (Size, Weight, And Power) constraints than general purpose computing systems. Examples of the embedded system 116 may include components of industrial machines, consumer electronics, automobiles, vehicles, agriculture machines, medical devices, cameras, household appliances, aircraft, spacecraft, weapons, and vending machines.

Each component may include additional, different, or fewer components. For example, both the circular storage memory 110 and the immutable memory 112 are shown in FIG. 1 as including the samples 124 and the security event 130. However, in other examples, the circular storage memory 110 may include different types of the forensic data 120 than the immutable memory 112. In still other examples, the data recorder memory 108 includes only circular storage memory 110 or only immutable memory 112.

As another example, the cyber security data recorder 102 may include the data recorder controller 104, the data recorder input interface 106, the read interface 114, and the hardware random number generator 122 but none of the other components shown in FIG. 1. In yet another example, the cyber security data recorder 102 may include the data recorder controller 104, the data recorder input interface 106, and the read interface 114 but none of the other components shown in FIG. 1.

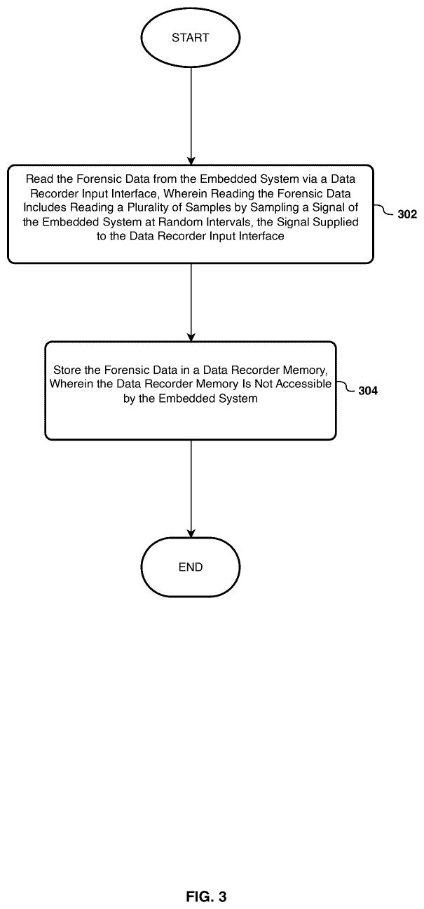

FIG. 3 illustrates a flow diagram of a first example of logic for gathering the forensic data 120 about the embedded system 116. The operations may include additional, different, or fewer operations than illustrated in FIG. 3.

In a first operation 302, the forensic data 120 may be read from the embedded system 116 via the data recorder input interface 106. Reading the forensic data 120 includes reading the samples 124 by sampling the signal 128 of the embedded system 116 at random intervals, where the signal 128 is supplied to the data recorder input interface 106. In some examples, sampling the signal 128 of the embedded system 116 at random intervals includes reading the samples 124 of the signal 128 at randomly varying constant sampling rates.

In a second operation 304, the forensic data 120 may be stored in a data recorder memory 108, where the data recorder memory 108 is not accessible by the embedded system 116.

Operations may end by, for example, returning to the first operation 302 to read additional data and/or ceasing operations.

The logic illustrated in the flow diagram may include additional, different, or fewer operations than illustrated. The operations illustrated may be performed in an order different than illustrated.

To clarify the use of and to hereby provide notice to the public, the phrases “at least one of <A>, <B>, . . . and <N>” or “at least one of <A>, <B>, . . . or <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed. Unless otherwise indicated or the context suggests otherwise, as used herein, “a” or “an” means “at least one” or “one or more.”

While various examples have been described, it will be apparent to those of ordinary skill in the art that many more examples and implementations are possible. Accordingly, the examples described herein are not the only possible examples and implementations.

The subject-matter of the disclosure may also relate, among others, to the following aspects:

A first aspect relates to a cyber security data recorder comprises: a data recorder controller; a data recorder memory; and a data recorder input interface configured to receive a signal from an embedded system, wherein the data recorder controller is configured to read a forensic data from the embedded system via the data recorder input interface, the forensic data including a plurality of samples of the signal of the embedded system, wherein the data recorder controller is configured to read the samples at intervals that are random and unknown to the embedded system, and wherein the data recorder controller is configured to store the forensic data in the data recorder memory.

A second aspect relates to the cyber security data recorder of aspect 1, wherein the data recorder memory comprises immutable memory, and wherein the data recorder controller is configured to store the forensic data in the immutable memory.

A third aspect relates to the cyber security data recorder of any preceding aspect, wherein the data recorder memory comprises a circular storage memory, and wherein the data recorder controller is configured to store the forensic data in the circular storage memory.

A fourth aspect relates to the cyber security data recorder of any preceding aspect, wherein the data recorder input interface is the only interface between the cyber security data recorder and the embedded system, and the data recorder input interface enables the data recorder controller to sample the signal, but not to receive any instruction from the embedded system and not to send any data to the embedded system.

A fifth aspect relates to the cyber security data recorder of any preceding aspect further comprising a hardware random number generator, wherein the intervals that are random are based on numbers generated by the hardware random number generator.

A sixth aspect relates to the cyber security data recorder of any preceding aspect, wherein the data recorder controller is configured to throttle a rate at which the data recorder controller stores the forensic data in the data recorder memory.

A seventh aspect relates to the cyber security data recorder of any preceding aspect, wherein the data recorder controller is configured to stop storing a type of the forensic data in the data recorder memory or switch to storing a summary of the type of the forensic data in response to a determination that a rate at which the type of the forensic data is detected exceeds a limit.

An eighth aspect relates to a method of gathering a forensic data about an embedded system, the method comprising: reading the forensic data from the embedded system via a data recorder input interface, wherein reading the forensic data includes reading a plurality of samples by sampling a signal of the embedded system at random intervals, the signal supplied to the data recorder input interface; and storing the forensic data in a data recorder memory, wherein the data recorder memory is not accessible by the embedded system.

A ninth aspect relates to the method of aspect 8, wherein the signal identifies power consumed by a processor of the embedded system.

A tenth aspect relates to the method of any preceding aspect, wherein the signal includes an indication of memory access rates of a processor of the embedded system.

An eleventh aspect relates to the method of any preceding aspect, wherein the signal includes instructions on an instruction bus of a processor of the embedded system.

A twelfth aspect relates to the method of aspect 11, further comprising including a rate of jump instructions, a ratio of jump to non-jump instructions, and/or an instruction rate in the forensic data stored in the data recorder memory.

A thirteenth aspect relates to the method of aspect 11, further comprising starting to store the forensic data in the data recorder memory in response to detection of a security event.

A fourteenth aspect relates to the method of any preceding aspect, wherein the random intervals at which the signal is sampled are selected to stay within a data rate limit.

A fifteenth aspect relates to a cyber security system for recording forensic data, the cyber security system comprising: a data recorder controller; a data recorder memory; and a data recorder input interface configured to receive a signal from an embedded system, wherein the data recorder controller is configured to read a forensic data from the embedded system via the data recorder input interface, the forensic data including a plurality of samples of the signal of the embedded system, wherein the data recorder controller is configured to read the samples of the signal at randomly varying constant sampling rates, and wherein the data recorder controller is configured to store the forensic data in the data recorder memory.

A sixteenth aspect relates to the system of aspect 15, wherein the forensic data includes side channel data.

A seventeenth aspect relates to the system of any preceding aspect further comprising a clock, a power source, and/or a reset circuit independent of a corresponding clock, a corresponding power source, and/or a corresponding reset circuit of the embedded system.

An eighteenth aspect relates to the system of any preceding aspect further comprising a read interface configured to access the data recorder memory, wherein read interface is accessible only if the cyber security system and/or the data recorder memory is physically separated from a circuit board.

A nineteenth aspect relates to the system of any preceding aspect further comprising a read interface configured to access the data recorder memory, wherein the read interface is configured to require cryptographic authentication for access to the data recorder memory.

A twentieth aspect relates to the system of any preceding aspect further comprising a fuse, wherein the data recorder controller is configured to cause the fuse to blow in response to detection of a security event.

In addition to the features mentioned in each of the independent aspects enumerated above, some examples may show, alone or in combination, the optional features mentioned in the dependent aspects and/or as disclosed in the description above and shown in the figures.

What is claimed is:

1. A cyber security data recorder comprising:
a data recorder controller;
a data recorder memory; and
a data recorder input interface configured to receive a signal from an embedded system,
wherein the data recorder controller is configured to read a forensic data from the embedded system via the data recorder input interface, the forensic data including a plurality of samples of the signal of the embedded system,
wherein the data recorder controller is configured to read the samples at intervals that are random and unknown to the embedded system, and
wherein the data recorder controller is configured to store the forensic data in the data recorder memory.

2. The cyber security data recorder of claim 1, wherein the data recorder memory comprises immutable memory, and wherein the data recorder controller is configured to store the forensic data in the immutable memory.

3. The cyber security data recorder of claim 1, wherein the data recorder memory comprises a circular storage memory, and wherein the data recorder controller is configured to store the forensic data in the circular storage memory.

4. The cyber security data recorder of claim 1, wherein the data recorder input interface is the only interface between the cyber security data recorder and the embedded system, and the data recorder input interface enables the data recorder controller to sample the signal, but not to receive any instruction from the embedded system and not to send any data to the embedded system.

5. The cyber security data recorder of claim 1 further comprising a hardware random number generator, wherein the intervals that are random are based on numbers generated by the hardware random number generator.

6. The cyber security data recorder of claim 1, wherein the data recorder controller is configured to throttle a rate at which the data recorder controller stores the forensic data in the data recorder memory.

7. The cyber security data recorder of claim 1, wherein the data recorder controller is configured to stop storing a type of the forensic data in the data recorder memory or switch to storing a summary of the type of the forensic data in response to a determination that a rate at which the type of the forensic data is detected exceeds a limit.

8. A method of gathering a forensic data about an embedded system, the method comprising:
reading the forensic data from the embedded system via a data recorder input interface, wherein reading the forensic data includes reading a plurality of samples by sampling a signal of the embedded system at random intervals, the signal supplied to the data recorder input interface; and
storing the forensic data in a data recorder memory, wherein the data recorder memory is not accessible by the embedded system.

9. The method of claim 8, wherein the signal identifies power consumed by a processor of the embedded system.

10. The method of claim 8, wherein the signal includes an indication of memory access rates of a processor of the embedded system.

11. The method of claim 8, wherein the signal includes instructions on an instruction bus of a processor of the embedded system.

12. The method of claim 11, further comprising including a rate of jump instructions, a ratio of jump to non-jump instructions, and/or an instruction rate in the forensic data stored in the data recorder memory.

13. The method of claim 11, further comprising starting to store the forensic data in the data recorder memory in response to detection of a security event.

14. The method of claim 8, wherein the random intervals at which the signal is sampled are selected to stay within a data rate limit.

15. A cyber security system for recording forensic data, the cyber security system comprising:
a data recorder controller;
a data recorder memory; and
a data recorder input interface configured to receive a signal from an embedded system,
wherein the data recorder controller is configured to read a forensic data from the embedded system via the data recorder input interface, the forensic data including a plurality of samples of the signal of the embedded system,
wherein the data recorder controller is configured to read the samples of the signal at randomly varying constant sampling rates, and
wherein the data recorder controller is configured to store the forensic data in the data recorder memory.

16. The system of claim 15, wherein the forensic data includes side channel data.

17. The system of claim 15 further comprising a clock, a power source, and/or a reset circuit independent of a corresponding clock, a corresponding power source, and/or a corresponding reset circuit of the embedded system.

18. The system of claim 15 further comprising a read interface configured to access the data recorder memory, wherein read interface is accessible only if the cyber security system and/or the data recorder memory is physically separated from a circuit board.

19. The system of claim 15 further comprising a read interface configured to access the data recorder memory, wherein the read interface is configured to require cryptographic authentication for access to the data recorder memory.

20. The system of claim 15 further comprising a fuse, wherein the data recorder controller is configured to cause the fuse to blow in response to detection of a security event.
